(19) United States
(12) Patent Application Publication
(10) Pub. No.: US 2020/0108327 A1
(43) Pub. Date: Apr. 9, 2020

(54) High Purity Distillation Process Control

(71) Applicant: UOP LLC, Des Plaines, IL (US)

(72) Inventors: Raul A. Ohaco, Glenview, IL (US); Jorge Charr, Northbrook, IL (US)

(21) Appl. No.: 16/154,138

(22) Filed: Oct. 8, 2018

(51) Int. Cl. B01D 3/42; B01D 3/14; G06F 15/18; G06G 7/58; G01N 30/02

(52) U.S. Cl. CPC B01D 3/42; B01D 3/143; G01N 2030/025; G06G 7/58; G01N 30/02; G06F 15/18

(57) ABSTRACT

Methods, systems, and apparatuses for modifying plant operating conditions for production of a product based on composition measurements associated with a distillation column. A control device may receive one or more composition measurements from a composition measurement device. The measurements may be associated with a distillation column of the plant. Based on the measurements, the control device may determine control instructions, e.g., using a history of control instructions. The plant may, based on the control decisions, interpret and implement the instructions. For example, the fuel flow to a burner or flow rate of a nozzle may be modified.

### FIELD

The present disclosure is related to a method and system for controlling the operation of a plant, such as a chemical plant or a petrochemical plant or a refinery, and more particularly to a method for improving control in a plant. Plants may be those that provide catalytic dehydrogenation or hydrocarbon cracking, or catalytic reforming, or other process units.

### BACKGROUND

A plant or refinery may be routinely monitored and controlled to produce a product. Because process variables of interest (e.g., those associated with one or more distillation columns) may interact with other process variables of interest, control methods implemented in current plants and/or refineries are often insufficient for optimizing plant operations. This problem is particularly of concern when implemented in plants and/or refineries with high purity distillation columns, which exhibit very long process lags and process dead times, both of which may impede plant monitoring and control. Though some plants implementing high purity distillation columns use basic control methods to improve yield, because feed and/or product composition variables are difficult to measure, only a limited amount of information may be available to make control decisions. Indeed, even when composition variable analyzers are implemented, measurements can often take fifteen to thirty minutes, limiting the speed and responsiveness of control decisions. Similarly, current single-input, single-output (SISO) and multivariable approaches (e.g., using multivariable predictive control (MPC)) alone, maybe insufficient for responsive plant control: SISO methods are unable to account for the complex interactions between multiple variables in a plant, whereas current MPC controller implementations relying solely on inferences updated with low frequency laboratory, negatively affect the performance of the unit.

Failure to measure and control a portion of, for example, a distillation column can result in production inefficiencies. For example, losses of propylene to distillation column bottoms in a propane-propylene splitter are typically not measured and/or controlled, resulting in plant inefficiencies and decreasing plant yield. Measurement of the temperature of column bottoms alone is insufficient to solve this problem, as the temperature of a liquid-gas mixture in a high quality distillation column is relatively insensitive to compositional changes.

### SUMMARY

The following summary presents a simplified summary of certain features. The summary is not an extensive overview and is not intended to identify key or critical elements.

One or more embodiments may include methods, computing devices, and/or systems for control of a plant using composition measurements. A composition measurement device may be configured to measure the composition of a reactant, catalyst, product, or intermediary product at a plant. The composition measurement device may take measurements associated with a distillation column. The composition measurement device may be configured to measure gas at the bottom of a high purity distillation column. The composition measurement device may transmit measurements to a controller device, which may process and/or store the measurements. The controller device may use the measurements for control processes, e.g., multivariable control and/or optimization processes and/or process simulation. Based on the processing, the controller may be configured to transmit instructions to one or more devices associated with the plant.

Other technical features may be readily apparent to one skilled in the art from the following figures, descriptions, and claims.

### BRIEF DESCRIPTION OF DRAWINGS

The present disclosure is illustrated by way of example and not limited in the accompanying figures in which like reference numerals indicate similar elements and in which:

FIG. 1A shows an example catalytic dehydrogenation process in accordance with one or more example embodiments.

FIG. 1B shows an example fluid catalytic cracking process in accordance with one or more example embodiments.

FIG. 2 depicts an illustrative catalytic reforming process using a (vertically-oriented) combined feed-effluent (CFE) exchanger in accordance with one or more example embodiments.

FIG. 3 depicts an illustrative catalytic dehydrogenation process (OLEFLEX) with continuous catalyst regeneration (CCR) using a (vertically-oriented) hot combined feed-effluent (HCFE) exchanger in accordance with one or more example embodiments.

FIG. 4A shows an example network diagram including a composition measurement device and a plant.

FIG. 4B shows a data collection platform in a plant.

FIG. 5 shows an example flow chart in accordance with features described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

### Chemical Plants and Catalysts

As a general introduction, chemical plants, petrochemical plants, and/or refineries may include one or more pieces of equipment that process one or more input chemicals to create one or more products. For example, catalytic dehydrogenation can be used to convert paraffins to the corresponding olefin, e.g., propane to propene, or butane to butene. References herein to a “plant” are to be understood to refer to any of various types of chemical and petrochemical manufacturing or refining facilities.

To produce one or more products, a chemical plant or a petrochemical plant or a refinery may use a distillation column. A distillation column may allow for the retrieval of different fractions of an input substance at different boiling ranges. For example, a first fraction with a low boiling point (e.g., butane or propane) may be retrieved at a low temperature, whereas a second fraction with a higher boiling point (e.g., naphtha or kerosene) may be retrieved at a higher temperature. Plant operators often control the operation of such distillation columns (e.g., the temperature of the distillation column) to produce a particular desired product. For example, a plant operator may increment through various temperatures in order to retrieve (and thereby divide) different fractions of an input substance. Portions of the input substance located at the bottom of such a column may be colloquially referred to as “bottoms,” and may comprise portions of the substance not retrieved. Conversely, portions of the input substance boiled as liquid and/or vapor may be referred to as the “distillate.” Generally, the retrieved fraction of the input substance is retrieved from the distillate.

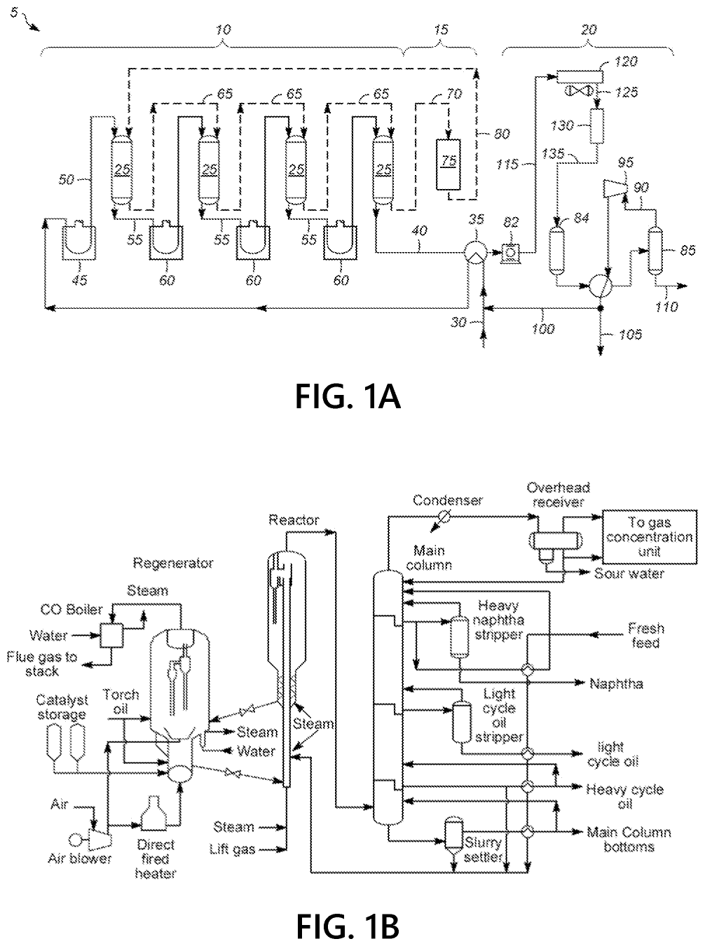

FIG. 1A shows an example of a catalytic dehydrogenation process 5. The process 5 includes a reactor section 10, a catalyst regeneration section 15, and a product recovery section 20.

The reactor section 10 includes one or more reactors 25. A hydrocarbon feed 30 is sent to a heat exchanger 35 where it exchanges heat with a reactor effluent 40 to raise the feed temperature. The hydrocarbon feed 30 is sent to a preheater 45 where it is heated to the desired inlet temperature. The heated feed 50 is sent from the charge heater 45 to the first reactor 25. Because the dehydrogenation reaction is endothermic, the temperature of the effluent 55 from the first reactor 25 is less than the temperature of the heated feed 50. The effluent 55 is sent to interstage heaters 60 to raise the temperature to the desired inlet temperature for the next reactor 25.

After the last reactor, the reactor effluent 40 is sent to the heat exchanger 35, and heat is exchanged with the feed 30. The reactor effluent 40 is then sent to the product recovery section 20. The catalyst 65 moves through the series of reactors 25. When the catalyst 70 leaves the last reactor 25, it is sent to the catalyst regeneration section 15. The catalyst regeneration section 15 includes a regenerator 75 where coke on the catalyst is burned off and the catalyst may go through a reconditioning step. A regenerated catalyst 80 is sent back to the first reactor 25.

The reactor effluent 40 is compressed in the compressor or centrifugal compressor 82. The compressed effluent 115 is introduced to a cooler 120, for instance a heat exchanger. The cooler 120 lowers the temperature of the compressed effluent. The cooled effluent 125 (cooled product stream) is then introduced into a chloride remover 130, such as a chloride scavenging guard bed. The chloride remover 130 includes an adsorbent, which adsorbs chlorides from the cooled effluent 125 and provides a treated effluent 135. Treated effluent 135 is introduced to a drier 84.

The dried effluent is separated in separator 85. Gas 90 is expanded in expander 95 and separated into a recycle hydrogen stream 100 and a net separator gas stream 105. A liquid stream 110, which includes the olefin product and unconverted paraffin, is sent for further processing, where the desired olefin product is recovered and the unconverted paraffin is recycled to the dehydrogenation reactor 25.

FIG. 1B shows an example of a fluid catalytic cracking (FCC) process, which includes an FCC fluidized bed reactor and a spent catalyst regenerator. Regenerated cracking catalyst entering the reactor, from the spent catalyst regenerator, is contacted with an FCC feed stream in a riser section at the bottom of the FCC reactor, to catalytically crack the FCC feed stream and provide a product gas stream, comprising cracked hydrocarbons having a reduced molecular weight, on average, relative to the average molecular weight of feed hydrocarbons in the FCC feed stream. As shown in FIG. 1B, steam and lift gas are used as carrier gases that upwardly entrain the regenerated catalyst in the riser section, as it contacts the FCC feed. In this riser section, heat from the catalyst vaporizes the FCC feed stream, and contact between the catalyst and the FCC feed causes cracking of this feed to lower molecular weight hydrocarbons, as both the catalyst and feed are transferred up the riser and into the reactor vessel. A product gas stream comprising the cracked (e.g., lower molecular weight) hydrocarbons is separated from spent cracking catalyst at or near the top of the reactor vessel, e.g., using internal solid/vapor separation equipment, such as cyclone separators. This product gas stream, essentially free of spent cracking catalyst, then exits the reactor vessel through a product outlet line for further transport to the downstream product recovery section.

The spent or coked catalyst, following its disengagement or separation from the product gas stream, requires regeneration for further use. This coked catalyst first falls into a dense bed stripping section of the FCC reactor, into which steam is injected, through a nozzle and distributor, to purge any residual hydrocarbon vapors that would be detrimental to the operation of the regenerator. After this purging or stripping operation, the coked catalyst is fed by gravity to the catalyst regenerator through a spent catalyst standpipe.

FIG. 1B depicts a regenerator, which can also be referred to as a combustor. Regenerators may have various configurations. In the spent catalyst regenerator, a stream of oxygen-containing gas, such as air, is introduced to contact the coked catalyst, burn coke deposited thereon, and provide regenerated catalyst, having most or all of its initial coke content converted to combustion products, including CO2, CO, and H2O vapors that exit in a flue gas stream. The regenerator operates with catalyst and the oxygen-containing gas (e.g., air) flowing upwardly together in a combustor riser that is located within the catalyst regenerator. At or near the top of the regenerator, following combustion of the catalyst coke, regenerated cracking catalyst is separated from the flue gas using internal solid/vapor separation equipment (e.g., cyclones) to promote efficient disengagement between the solid and vapor phases.

In the FCC recovery section, the product gas stream exiting the FCC reactor is fed to a bottoms section of an FCC main fractionation column. Several product fractions may be separated on the basis of their relative volatilities and recovered from this main fractionation column. Typical product fractions include, for example, naphtha (or FCC gasoline), light cycle oil, and heavy cycle oil.

Other petrochemical processes produce products such as turbine fuel, diesel fuel, and other products referred to as middle distillates, as well as lower boiling hydrocarbon liquids, such as naphtha and gasoline, by hydrocracking a hydrocarbon feedstock derived from crude oil or heavy fractions thereof. Feedstocks most often subjected to hydrocracking are the gas oils and heavy gas oils recovered from crude oil by distillation.

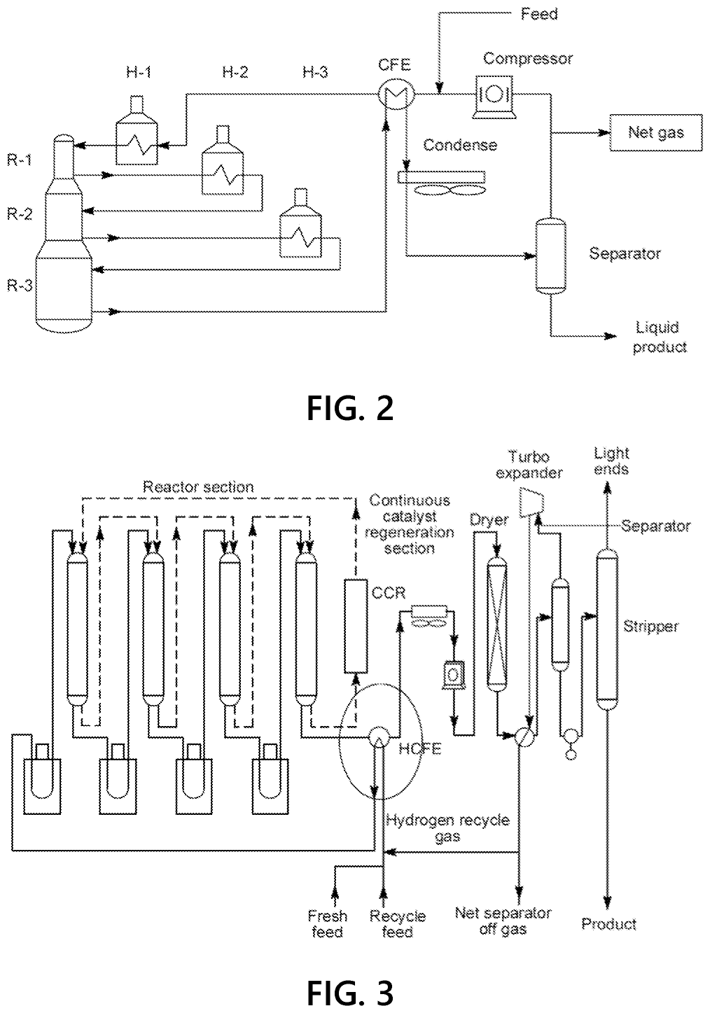

FIG. 2 shows an example of a process for reforming with continuous catalyst regeneration (CCR) using a (vertically oriented) combined feed-effluent (CFE) exchanger. The cold stream, a combination of liquid feed with hydrogen rich recycle gas (e.g., light paraffins), is introduced into a CFE exchanger where the feed is vaporized. The feed/recycle exits the CFE as a gas and goes through a series of heating and reaction steps, such as through heaters H-1, H-2, H-3 and reactors R-1, R-2 and R-3. The resulting product effluent or hot stream is introduced into the CFE exchanger and is cooled down. The effluent exits the CFE exchanger and is then cooled down further and condensed using an air cooler. The liquid product is separated from the gas stream containing hydrogen and light paraffins. Some of the gas stream is removed, for example as a product, and the rest of the stream is used as recycle gas.

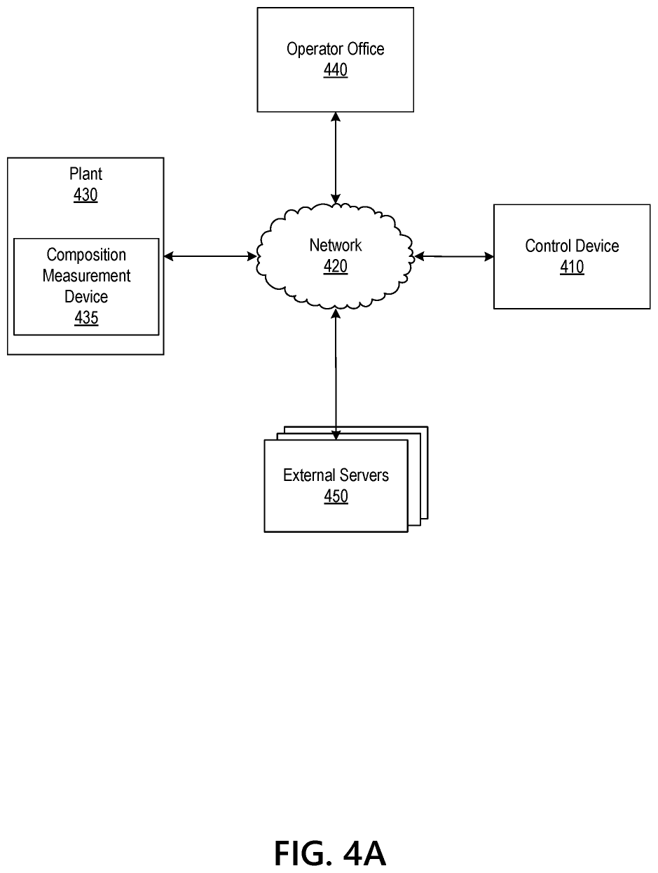

FIG. 3 shows a catalytic dehydrogenation process (e.g., an OLEFLEX process) with continuous catalyst regeneration (CCR) using a (vertically-oriented) hot combined feed-effluent (HCFE) exchanger 300. The cold stream, a combination of vapor feed with hydrogen rich recycle gas, is introduced into a HCFE exchanger and is heated. The feed/recycle exits the HCFE as a gas and goes through a series of heating and reaction steps. The resulting product effluent or hot stream is introduced into the HCFE exchanger and is cooled down. The effluent exits the HCFE exchanger and is then cooled down further using an air cooler. The effluent then passes through a dryer, separators, and strippers. Hydrogen recycle gas is separated after the dryer and returned to the feed stream.

### Process Control

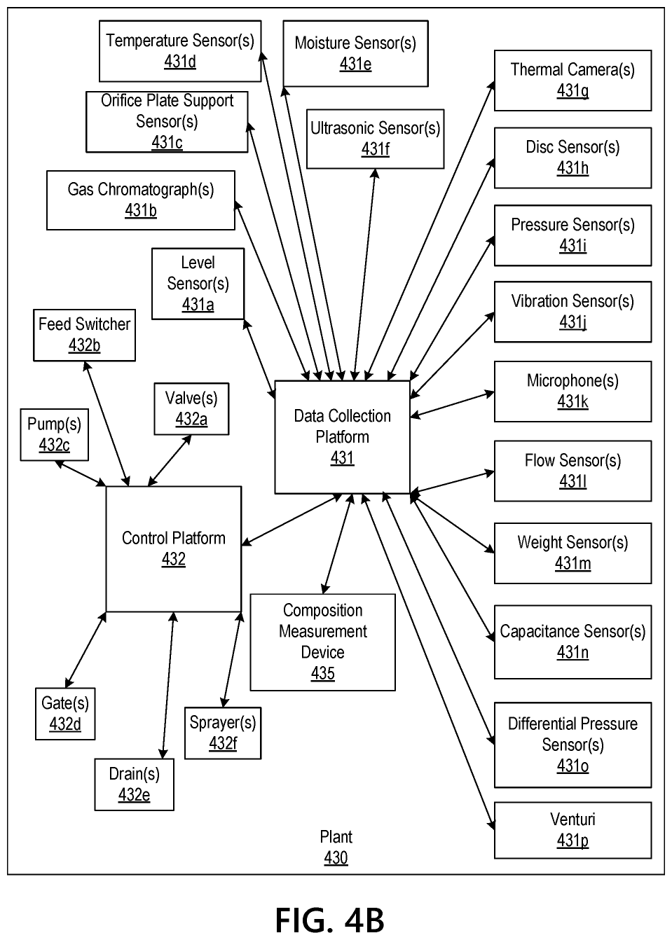

FIG. 4A shows an example network diagram comprising a control device 410. The control device 410 may be connected, via a network 420, to a plant 430, an operator office 440, and/or external servers 450. Though the control device 410 is shown separately from the plant 430, the control device 410 may be inside or part of the plant 430, such that, for example, the network 420 may comprise both an external and internal network. The plant 430 may, for example, be configured to perform the catalytic dehydrogenation process of FIG. 1A, the fluid catalytic cracking process shown in FIG. 1B, and/or the processes shown in FIGS. 2 and 3. As such, the plant may comprise, for example, heat exchangers, distillation columns, regenerators, and similar elements as described above, including a composition measurement device 435. The plant 430 may comprise one or more computing devices (not shown) configured to implement such processes. For example, one or more computing devices at the plant 430 may be configured to manage and control distillation columns, including receiving instructions on control of such distillation columns.

The control device 410 may be one or more computing devices, such as one or more servers (e.g., a cloud computing platform), configured to receive composition measurements and transmit control instructions. Computing devices described herein may comprise any form of device configured with one or more processors and/or memory storing instructions that, when executed by the processor, perform one or more steps. The control device 410 may be configured to receive, from the composition measurement device 435 at the plant 430, measurements associated with the plant 430. The control device 410 may additionally or alternatively receive other plant data from other devices. The control device 410 may be configured to process the received measurements and/or other plant data, such as by performing error-detecting routines, organizing the measurements, reconciling the measurements and/or other plant data with a template or standard, and/or storing the received measurements and/or other plant data, as discussed in greater detail below. As discussed in greater detail below, based on the measurements and any other plant data, the control device 410 may be configured to determine one or more control instructions and transmit the control instructions to one or more devices associated with the plant 430, the operator office 440, and/or the external servers 450. By way of example, such control instructions may include an instruction to adjust, open, or close a valve, gate, drain, or other portions of the plant 430. As a simplified example, based measurements and other plant data indicating that a temperature exceeds a threshold, the control device 410 may cause a vent or valve to open.

Though the control device 410 is depicted as a single element in FIG. 4A, it may be a distributed network of computing devices located in a plurality of different locations. For example, the control device 410 may operate on a plurality of different servers distributed worldwide, the plant 430 may be in a first town, and the operator office 440 may be in a second town. As another example, the operator office 440 and the control device 410 may be in the same location and/or part of the same organization, such that the same computing device acting as the control device 410 may operate on behalf of the operator office 440. As yet another example, the control device 410 may be located inside of the plant 430, such that, as noted above, the network 420 may be all or partially inside the plant 430. The control device 410 may comprise instructions executed by one or more processors. For example, the control device 410 may be an executable file.

The control device 410 may use a plurality of different mechanisms by which received measurements and/or other plant data may be processed and interpreted. The control device 410 may process and/or analyze received measurements and/or other plant data. For example, the control device 410 may be configured to execute code that compares all or portions of the measurements and/or other plant data to threshold values and/or ranges. Machine learning algorithms may be used to process and/or interpret received measurements and/or other plant data. The compositional data may be used in convolution models to determine the dynamic behavior of the unit in order to perform the required adjustments on the manipulated variables to optimize the main products yields and/or produced flowrate and/or energy consumption. Dynamic predictive models may be updated based on the compositional data in the feed and/or other streams in order to predict the future behavior and allow the control device 410 to perform the required actions to reject process disturbances and upsets and/or respond to operational changes in an optimum manner. For example, the control device 410 may store and use old measurements to teach a machine learning algorithm target ranges for new measurements, and the new measurements may be input into the machine learning algorithm to determine if an undesirable plant condition exists.

The control device 410 may be configured to determine, based on one or more measurements and/or other plant data, control instructions. Control instructions may comprise any instruction to modify any aspect of the plant 430, as discussed in greater detail below. For example, control instructions may comprise an instruction to increase or decrease temperature, pressure, and/or flow rate. The control instructions may cause the plant 430 to, for example, open or close one or more valves and/or drains, change the operating parameters of pumps, feed switchers, gates, and/or sprayers, or similar actions. The control instructions may be based on the configuration of the plant. For example, the control instructions may not contain an instruction to a plant to increase humidity responsive to determining that the plant does not have a device that can increase humidity.

The control device 410 may be configured to transmit the control instructions to one or more devices associated with the plant 430, the operator office 440, and/or the external servers 450. One or more intermediary devices may be configured to receive and implement the control instructions. The one or more intermediary devices may process and interpret received control instructions to implement the control instructions. For example, the control instructions may comprise an indication to increase temperature by a certain amount, and an intermediary device may interpret these instructions by increasing the flow of fuel gas to a plurality of burners.

The network 420 may be a public network, a private network, or a combination thereof that communicatively couples the control device 410 to other devices. Communications between devices such as the computing devices of the plant 430 and the control device 410, may be packetized or otherwise formatted in accordance with any appropriate communications protocol. For example, the network 420 may comprise a network configured to use Internet Protocol (IP).

The plant 430 may be any of various types of chemical and petrochemical manufacturing or refining facilities. As will be discussed later, the plant 430 may be configured with one or more computing devices, in addition to the composition measuring device 435, which may report other plant data to the control device 410 via the network 420.

The operator office 440 may be configured to, via one or more computing devices of the operator office 440, receive measurements and/or other plant data and send such measurements and/or other plant data to the control device 410 and/or configure the plant 430. The operator office 440 may also transmit instructions to the control device 410. For example, the operator office 440 may configure, via the network 420, the control device 410 to specify one or more rules for control of the plant 430.

The composition measurement device 435 may be any device configured to measure the composition of a substance. As an example, the composition measurement device may be an Elster® EnCal 3000 manufactured by Honeywell Corporation of Morris Plains, N.J. The composition measurement device 435 may be configured to measure the composition of gas components. The composition measurement device 435 may be configured to report such measurements to the control device 410 at a set rate, such as every minute.

The composition measurement device 435 may be implemented at a plurality of locations in the plant 430. The composition measurement device 435 may be implemented in a vapor space of a distillation column sump (e.g., the lower portion of the main column depicted in FIG. 1B). The composition measurement device 435 may additionally or alternatively be located in the standpipe for the level control of a sump associated with a distillation column (e.g., the column depicted in FIG. 1B). The composition measurement device 435 may additionally or alternative be located in a portion of a distillation column (e.g., as shown in FIG. 1B) associated with advanced regulatory control (ARC). The composition measurement device 435 may be joined with devices that aid in maintaining the temperature and pressure of the flow through the composition measurement device 435. For example, the composition measurement device 435 may be connected to micromechanical columns, temperature control systems, and/or other devices to ensure that the gas fed into the composition measurement device 435 is at a temperature and/or pressure that maximizes the accuracy of composition measurements. Though one device is shown, multiple composition measurement devices may be implemented.

FIG. 4B shows an example of the plant 430 comprising a data collection platform 431 connected to a control platform 432. The data collection platform 431 is connected to sensors 431a-p and to the composition measurement device 435. The control platform 432 is connected to controllable devices 432a-f. The sensors and controllable devices depicted in FIG. 4B are examples, any number or type of sensors and/or controllable devices may be implemented, whether or not connected to the data collection platform 431 or the control platform 432.

The data collection platform may be configured to collect plant data from one or more sensors and/or controllable devices and transmit that information, e.g., to the control device 410. For example, the composition measurement device 435 may be configured to send measurements to the data collection platform 431, which may send such measurements to the control device 410. Such sensors may further comprise, for example, level sensors 431a, gas chromatographs 431b, orifice plate support sensors 431c, temperature sensors 431d, moisture sensors 431e, ultrasonic sensors 431f, thermal cameras 431g, disc sensors 431h, pressure sensors 431i, vibration sensors 431j, microphones 431k, flow sensors 431l, weight sensors 431m, capacitance sensors 431n, differential pressure sensors 431o, and/or venturi 431p. The data collection platform may additionally or alternatively be communicatively coupled to the control platform 432 such that, for example, the data collection platform 431 may receive, from the control platform 432 and/or any of the controllable devices 432a-f, operating information. The controllable devices 432a-f may comprise, for example, valves 432a, feed switchers 432b, pumps 432c, gates 432d, drains 432e, and/or sprayers 432f.

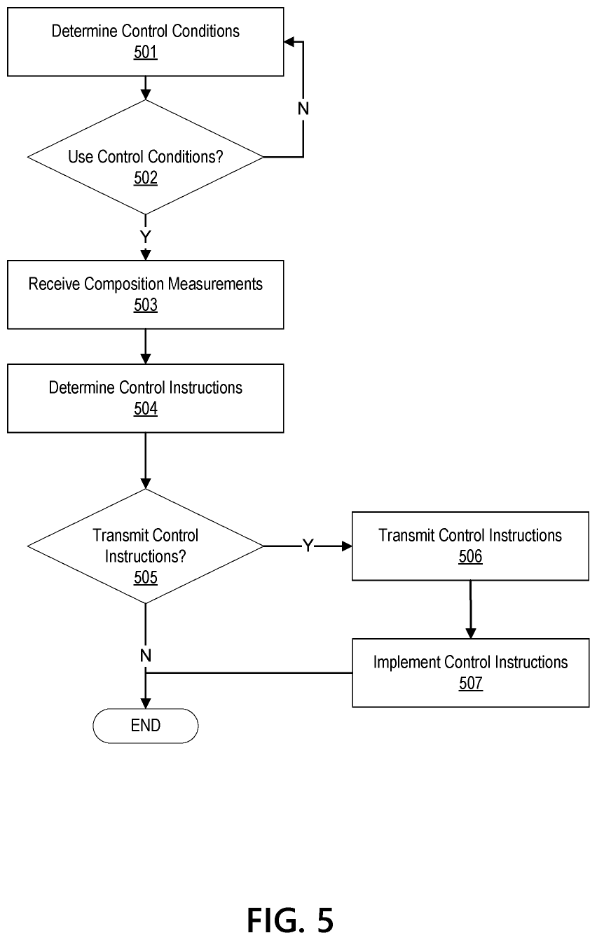

FIG. 5 shows a flowchart of a method that may be performed with respect to a control device. In step 501, the control device (e.g., the control device 410) may determine control conditions for a plant (e.g., the plant 430). Control conditions may comprise rules, operational limits, target measurements, or other related indications of desired plant operations. For example, control conditions may indicate a desired level of output from a distillation column or may indicate a target level of production for the plant. Control conditions may comprise a range of desired measurements (e.g., a certain range of the amount of a chemical in a certain intermediate product, or a range of inlet temperatures).

Control conditions may be determined using machine learning algorithms implemented on, for example, a neural network. Control conditions may be determined by an algorithm (e.g., a machine learning algorithm) based on analysis of a set of historical measurements and/or other plant data associated with a plant. As such, the control conditions need not be a fixed set of rules, but may comprise decision-making by the algorithm. In particular, the historical compositional data may be used to reconcile process models in order to determine different key variables (e.g. flooding conditions and/or tray efficiency) which may be sent to a visualization layer for operations/reliability plant teams consumption and/or employed to adjust constrains and/or optimization variables of the convoluted dynamic models implemented in the control device 410. If implemented as a machine learning algorithm, the machine learning algorithm may be a supervised machine learning algorithm (e.g., with feedback on output) or an unsupervised machine learning algorithm (e.g., without feedback on output). For example, the machine learning algorithm may be supervised such that an administrator or a monitoring device may provide positive feedback for control conditions which improve plant operations. As another example, the machine learning algorithm may be provided feedback via an indication of a yield made under specific control conditions.

Control conditions may comprise one or more limitations associated with the operation of a plant. Certain practical limitations may prevent the operation of a plant in a manner that otherwise may produce a desirable result. For example, increasing the temperature overhead of a distillation column to a higher temperature may potentially improve yield of a product; however, such a temperature increase may place undesirable mechanical stress on the distillation column or associated equipment. The control conditions may thus reflect physical limitations such as the mechanical limits of all or portions of a plant, practical limitations (e.g., that a plant equipment may only run under certain temperature or pressure limits), or the like.

Control conditions may be determined based on available methods of controlling a plant. A plant may be controlled in a variety of dimensions: flow rate, temperature, the speed of all or portions of the plant, the particular composition of a substance in the plant, or the like. Not all variables of a plant may be controlled. For example, if only the fuel flow to a burner at a plant may be controlled, the control conditions may be different than if, for example, both the fuel flow to a burner and flow rate of substances heated by the burner may be controlled. By way of particular example, if only the fuel flow to a burner may be controlled, then the control condition may be based on the fuel flow to the burner at a plant and/or other measurements at the plant which may be affected by fuel flow to the burner. As another example, if only the flow rate may be controlled, the control conditions may include both the temperature of an inlet valve as well as the flow rate, as both may, directly or indirectly, relate to the flow rate.

In step 502, the control device may determine whether to use the control conditions. In some cases, the control device may determine to change the control conditions before use as a response to, e.g., a given process variable measurement exceeding predefined control limits. Control conditions may change based on, for example, the changing conditions of a plant. Changes in the plant feed temperature, pressure, flow or composition, the presence of new equipment, wearing down of old equipment, changes in catalyst behavior, and changes in ambient temperature are all examples of reasons why control conditions may merit modification. Such variables may already be accounted for in control conditions. As such, control conditions need not be a static set of rules (e.g., that the temperature of product stream remains in a certain range), but may be an evolving set of conditions that seek to improve plant operations given current variables and methods of control. For example, in the case of a propylene-propane splitter of the catalytic dehydrogenation process (e.g., an OLEFLEX process), the efficiency loss of the trays with time may result in an increase of propylene in column bottoms which may affect the product yield and conversion in the reactors, thus reducing the propylene production. The efficiency loss may be determined using the compositional data compared with the start-of-run efficiency from a reconciled process model. As described in more detail later, this information may be used by the control device 410, which may for example adjust simultaneously the reboiler duty, the reflux flowrate, product draws and column pressure to reduce the propylene losses in the column bottoms while maintain the product specifications and optimizing energy consumption. If the control conditions should not be used or otherwise should be further changed, the flow chart returns to step 501. Otherwise, the flow chart proceeds to step 503.

In step 503, composition measurements may be received from a composition measurement device (e.g., the composition measurement device 435) at the plant. Additionally or alternatively, other plant data may be received from other devices associated with the plant. Such data may be received over a network in any manner, and need not arrive at the same time or frequency. For example, measurements and/or other plant data may be received at different times, and the control device may be configured to handle such data.

In step 504, the control device may, based on the composition measurements and/or other plant data received, determine control instructions for the plant. Control instructions may comprise an instruction to make no change or to make one or more changes to the operation of the plant.

The control instructions determined may be based on previous control instructions. For example, control instructions may be determined to repeat or not repeat previous control instructions. Control conditions may be determined based on a determination that previous control conditions were insufficient. Control conditions may be adjusted based on a history of control instructions such that, for example, control instructions do not undesirably oscillate over time.

Control instructions may be based on computer simulation of the plant. Software may simulate conditions at the plant. Control instructions in the simulation may be tested to determine optimum control conditions for the real-life plant. The simulation may comprise a flowsheet. For example, the control device may test thousands of different modifications to the simulated plant in order to determine the optimal control instructions to send to a real-life plant. Optimal control instructions need not be those that produce the best product, but may be selected based on a number of variables, such as which control instructions are the cheapest and/or the easiest to implement in the real-life plant. For example, it may be the case that the most valuable product may be produced by increasing the fuel flow to a burner significantly, but doing so may be cost-prohibitive.

The simulation executed by the control device may be modified, e.g., by an administrative computing device associated with an operator office and/or a plant. For example, the addition or removal of devices may be simulated. The simulation on future anticipated conditions. For example, if one reactor of a plurality of reactors is soon to be taken offline, the simulation may be based on the one reactor being absent. One or more conditions (e.g., the failure of all or portions of the reactor, ambient temperature conditions) may be tested on a regular basis.

Control instructions may be based on one or more rules established for control. The one or more rules may indicate, for example, that the control device should modify temperature before pressure, or that flow rate should only be modified under certain circumstances. The one or more rules may be determined based on material limitations of the plant. For example, a rule may specify that a valve have a flow rate no higher than 80% of its maximum limit in order to avoid wear on the valve and/or maintain controllability. As another example, to conserve energy, a rule may specify that only so many burners may be used, or that the burners may be only used with so much fuel per second. In the case of cryogenic units for example, depending on the market conditions the unit may operate on ethane rejection mode or on Ethane recovery mode. Different sets of constrains for the operating variables and/or optimization functions will be fed to the control device 410 to adjust the actions to maximize the plant production and or minimize energy consumption.

In step 505, the control device may determine whether to transmit the control instructions to the plant. If the control instructions indicate that the plant should not make a change, the control device may not transmit control instructions. The control device may be configured transmit control instructions only when the control instructions meet a predetermined threshold (e.g., when an instructed temperature change exceeds a certain number of degrees change). If the control device decides to transmit the control instructions, they may be transmitted in step 506.

In step 507, the control instructions may be implemented. For example, the plant may, based on the instructions, cause actions (e.g., the actuation of a motor) to open or close a valve, modify a flow rate, or the like. The control instructions may not comprise instructions for all actions; rather, one or more computing devices may be configured to interpret and implement the instructions with respect to the plant.

Steps 501 through 504 may be rearranged and performed in a different order. For example, composition measurements may be received in step 503 before control conditions are determined in step 501. As another example, the decision in step 502 may not be performed until after steps 503 and 504, such that the control conditions may be compared to the composition measurements and/or the control instructions.

As an example of steps 501 through 507, the composition measurement device 435 may be a micro gas-chromatograph analyzer such as the Elster® EnCal 3000 manufactured by Honeywell Corporation of Morris Plains, N.J. Control conditions may be determined in step 501 and selected for use in step 502. The composition measurement device 435 may measure the composition of multiple streams in and around a high-purity distillation column. These measurements may be received in step 503 and, based on these measurements, control instructions may be determined in step 504. Based on determining to transmit the control instructions in step 505, the control instructions may be transmitted in step 506 and implemented in a plant in step 507. In this way, the process described in steps 501 through 507 may control and optimize high-purity distillation columns by advantageously decoupling highly interactive process variables using an Advance Process Control and/or Multivariable Predictive Controller.

### CONCLUSION

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps illustrated in the illustrative figures may be performed in other than the recited order, and one or more depicted steps may be optional in accordance with aspects of the disclosure.

What is claimed is:

1. A system comprising:
a control device comprising:
one or more processors; and
memory storing instructions; and
a plant comprising:
a distillation column; and
a computing device configured to manage production of a product using the distillation column;
wherein the instructions, when executed by the one or more processors, cause the control device to:
determine control conditions for the plant, wherein the control conditions correspond to operating conditions of the plant;
receive, via a network, one or more measurements from a composition measurement device associated with the plant, wherein the measurements indicate a composition of a substance associated with the distillation column;
determine, based on the one or more measurements and using the control conditions, a control instruction for the plant; and
transmit the control instruction to the computing device; and
wherein the computing device is configured to:
adjust, based on the control instruction, production of the product using the distillation column.

2. The system of claim 1, wherein the composition measurement device measures gas associated with a vapor space of the distillation column.

3. The system of claim 1, wherein the instructions, when executed by the one or more processors, further cause the control device to:
receive, from one or more sensors associated with the plant, plant data, wherein determining the control instruction for the plant is further based on the plant data.

4. The system of claim 1, wherein the composition measurement device is a gas chromatograph analyzer.

5. The system of claim 1, wherein the instructions, when executed by the one or more processors, further cause the control device to:
receive, from a second composition measurement device located at a process regulatory control portion of the distillation column, one or more second measurements associated with the distillation column, wherein the control instruction is further based on the one or more second measurements.

6. A method comprising:
determining, by a computing device, control conditions for a plant comprising a distillation column, wherein the control conditions correspond to operating conditions of the plant;
receiving, via a network, one or more measurements from a composition measurement device associated with the plant, wherein the measurements indicate a composition of a substance associated with the distillation column;
determining, by the computing device, based on the one or more measurements, and using the control conditions, a control instruction for the plant; and
causing adjusting, based on the control instruction, of equipment associated with the distillation column.

7. The method of claim 6, wherein the composition measurement device measures gas associated with a vapor space of the distillation column.

8. The method of claim 6, comprising:
adjusting the control instruction based on a history of control instructions determined by the computing device.

9. The method of claim 6, further comprising:
receiving, from one or more sensors associated with the plant, plant data, wherein determining the control instruction for the plant is further based on the plant data.

10. The method of claim 6, wherein the composition measurement device is a gas chromatograph analyzer.

11. The method of claim 10, wherein the machine learning algorithm is an unsupervised machine learning algorithm, and wherein the machine learning algorithm is configured to determine control instructions based on plant yield.

12. The method of claim 6, further comprising:
receiving, from a second composition measurement device, one or more second measurements associated with the distillation column, wherein determining the control instruction for the plant is further based on the one or more second measurements.

13. The method of claim 12, wherein the second composition measurement device is located at a process regulatory control portion of the distillation column.

14. The method of claim 6, wherein determining the control instruction comprises:
simulating, by the computing device and based on the one or more measurements, the plant.

15. An apparatus comprising:
one or more processors; and
memory storing instructions that, when executed by the one or more processors, cause the apparatus to:
determine control conditions for a plant comprising a distillation column, wherein the control conditions correspond to operating conditions of the plant;
receive, via a network, one or more measurements from a composition measurement device associated with the plant, wherein the measurements indicate a composition of a substance associated with the distillation column;
determine, based on the one or more measurements and using the control conditions, a control instruction for the plant; and
causing adjusting, based on the control instruction, of equipment associated with the distillation column.

16. The apparatus of claim 15, wherein the composition measurement device measures gas associated with a vapor space of the distillation column.

17. The apparatus of claim 15, wherein determining the control instruction for the plant is further based on a history of control instructions.

18. The apparatus of claim 15, wherein the instructions, when executed by the one or more processors, further cause the apparatus to:
receive, from one or more sensors associated with the plant, plant data, wherein determining the control instruction for the plant is further based on the plant data.

19. The apparatus of claim 15, wherein the composition measurement device is a gas chromatograph analyzer.

20. The apparatus of claim 15, wherein the instructions, when executed by the one or more processors, further cause the apparatus to:
receive, from a second composition measurement device located at a process regulatory control portion of the distillation column, one or more second measurements associated with the distillation column, wherein determining the control instruction for the plant is further based on the one or more second measurements.
